(19) United States
(12) Patent Application Publication
(10) Pub. No.: US 2002/0044204 A1
(43) Pub. Date: Apr. 18, 2002

(54) Optical tracking system and method

(76) Inventors: Konrad Zurl, Nurnberg (DE); Kurt Achatz, Freising (DE); Armin Weiss, Diessen (DE)

Correspondence Address: SHLESINGER, ARKWRIGHT & GARVEY LLP, 3000 SOUTH EADS STREET, ARLINGTON, VA, 22202, US

(21) Appl. No.: 09/976,287

(22) Filed: Oct. 15, 2001

(30) Foreign Application Priority Data
Oct. 17, 2000 (DE) DE 100 51 415.4

(51) Int. Cl. H04N 5/225

(52) U.S. Cl. 348/169; 348/47

(57) ABSTRACT

In an optical tracking system for determining the position and/or orientation of an object provided with at least one marker (4), having at least two image recording devices (1) for capturing the images of said at least one marker (4) and at least one computing device (2, 3) for evaluating the images captured by said image recording devices (1), it is proposed to provide means for retransferring relevant information that was calculated by a computing device (2, 3) to another computing device (2) and/or to said image recording device (1) for controlling the computing process or the image recording. It is advantageous to retransfer expected values calculated by a prediction device (5). Hereby, a faster and more precise processing of the resulting image data is possible.

The present invention relates to an optical tracking system for determining the position and/or orientation of an object provided with at least one marker, having at least two image recording devices for capturing the image of said at least one marker and at least one computing device for evaluating the images captured by the image recording devices for computing the position and/or orientation of the object. Further, the invention relates to a corresponding tracking method, a computer program for implementing said method on a computer and also a computer program product having this program.

A tracking system and method of this kind for determining the position and orientation of a recording camera is known from DE-19806646 C1. For example, in order to be able to integrate a person filmed, precisely and true to position into a virtually created background, the respective position and orientation of the recording camera must be known. There, a tracking system having at least two light sources to be fitted to the camera, at least two viewer cameras for capturing images of said light sources and a computing device for evaluating these images is recommended. With an optimum number of light sources and viewer cameras, the position (three-dimensional location) and also the orientation (roll, tilt and pan angle) of the camera can be determined with sufficient accuracy. Advantageously, the light sources here are in the infrared range, so that these can be decoupled from the other light sources present in a studio. Commercially available CCD cameras are recommended as viewer cameras. The computation of position and orientation of the recording camera occurs in a data processing system by means of trigonometric calculations.

A tracking system, in which infrared flashes released by light emitting diodes in defined time slots are received time-resolved by a synchronized camera, is known from WO99/52094.

Further, in WO99/30182 a tracking system is defined, in which said at least three markers of an object arranged in a predefined geometric relation to one another are, for example, captured by means of rays reflected from these markers, and the position and orientation of the object can then be calculated by comparison with stored marker arrangements.

The use of active (energy emitting) and passive (energy reflecting) targets to track an object provided with such targets is known from WO99/17133.

In the present invention, any object provided with at least one marker is monitored simultaneously by at least two tracking cameras or image recording devices, the spatial position and orientation of which are known, so that from the images delivered by these cameras the location of the marker and thereby that of the object in space can be determined with help of trigonometric methods. For this, visual rays originating from the location of each tracking camera are constructed for each marker, the point of intersection of the rays in space defining the three-dimensional location of the marker. By using a plurality of markers per object, besides the three-dimensional position, the orientation of the object in space, i.e. a “6-D position” can also be calculated. The orientation of an object is determined by the relative rotation of the object in space and the rotation around itself.

In the known and above described tracking systems, mostly the entire image area recorded by an image recording device (tracking camera) is read-out, digitized and scanned for markers. The positions of the markers found are subsequently calculated in two-dimensions (in the image coordinates) exactly. This data is forwarded to a host computer or a central computing process, where the data recorded by a plurality of image recorders at a time are collected. Further calculations, from which the position and/or orientation of the objects to be tracked is obtained, are based on this.

This separation of the individual operation steps has many disadvantages. Thus, for example, the readout of the image recording device in image areas where no markers exist, occurs in the same way as in the actually relevant image areas in which markers are present. The readout of the image recording device is however one of the main time constraints for precision tracking systems of this type, since the pixel information is fed sequentially into an A/D converter, and since on the other hand, in general, an increase in the readout frequency has a negative effect on the achievable accuracy.

Hence, it is the object of the present invention, to avoid the above disadvantages of time and memory intensive tracking systems and to achieve considerable gains in time with unreduced or increased tracking accuracy. Particularly by using reflecting markers, an increased accuracy should be achieved in the determination of the marker position in comparison to the known systems.

This object is accomplished by the features of an optical tracking system according to claim 1 and also by a method for determining the position and/or orientation according to claim 13 and a corresponding computer program or computer program product according to claims 23 and 24, respectively. Advantages of the invention are disclosed in the respective subclaims and also in the following description.

In the tracking system according to the invention, at least one computing device for evaluating the images captured by the image recording devices and also means for retransferring information calculated by such a computing device to another computing device and/or to the image recording device are provided. Hereby, a bidirectional data transfer is possible, which in comparison to the present unidirectional data transfer offers appreciable advantages. The retransferred information is used for controlling the image recording and/or the image evaluation. Hereby, for example, information about location, size and luminosity of the relevant markers can be used for optimizing the image recording and also for handling the image areas, which are relevant and not relevant for the readout process, differently. Further, information about position or orientation of the object can be used for extrapolating the expected positions or orientations, and the image recording and evaluation can be organized accordingly.

The disadvantages of separating the individual computing steps in the direction from image recording to output of tracking result are overcome with the invention, by retransferring information, in particular, from the location where the first tracking results are available to the locations where the image recording and the first steps of image processing are executed (which are, in general, the image recording devices and the computing stages which determine the marker positions in the image).

Often, the computing stages for the image evaluation are separated not only logically, but also physically into a 2D-computing stage and a central 3D-/6D-computing stage connected to its output. In the 2D-computing stage, the marker positions are calculated in the image coordinates of the image recording device, so that often a computing stage of this type is directly allocated to each image recording device. From the data determined, the three dimensional position data or six dimensional position and orientation data is then calculated in a central computing device. In an arrangement of this type it is advantageous to retransfer information from the central computing device to the computing device allocated to an image recording device and if required, also to the image recording device itself. Hereby, the parameters for image recording can be controlled in the image recording device itself and set optimally and also the subsequent image processing in the 2D-computing stage can be optimized in dependence on the calculated position and/or orientation of the object.

In general, the retransferred information refers to the current tracking data that was determined for the direct past, and from which the current point of time can be inferred. Further, it can refer to current data loaded into the system from outside which is relevant for the tracking. Finally, it can refer to a priori information regarding the initial situation. When current tracking data is retransferred, then a closed control loop is formed, which in numerous situations offers potential for improvement compared to the present functioning with unidirectional information flow.

With the retransfer of information, valuable computing time can be saved and the accuracy can be enhanced in the readout process of the image recording device and also in the identification of markers and calculation of their two-dimensional positions.

It is also possible, for this purpose, to combine the 2D-computing stages, i.e. the computing devices allocated to the individual image recording devices, for delivering information or for forwarding information from the central computing device.

It is advantageous to incorporate a prediction device into the information retransfer, through which data of the directly preceding image recordings can be extrapolated to the data expected in the present image recording. Hereby, for example, expected marker positions can be calculated in the two-dimensional image and the following image processing can be limited to the area in which markers are expected. In the areas in which no markers are expected, the readout of the image recording device and the marker identification and position determination can be either entirely omitted or carried out with less accuracy or only in certain time intervals. This enhances the processing speed and saves memory space.

The information to be retransferred can also be the current or expected marker sizes. Nonspecific reflexes can then, only on the basis of an information regarding the size, be blanked out. The computing time for the time-consuming position determination of such reflexes is dispensed with, and can be used for an improvement in the calculation of the relevant markers.

Information about the current or expected appearance of artifacts (often owing to markers obscuring one another partially) can also be retransferred. Thereby, the calculation of the marker positions in the two-dimensional image can already be carried out with algorithms adapted to this situation. Hereby, the reliability, speed and accuracy of the position calculation for markers which are affected by artifacts increases.

For the data transfer in both directions, i.e. from the image recording to the image processing and reverse, it is advantageous to use physically the same information channel. The information transfer can then be executed by using separate frequency windows or time slots. An information transfer via Ethernet connections is appropriate.

With the invention, a particularly favorable application possibility results for tracking systems which operate with passive markers, i.e. such markers, which reflect electromagnetic rays in the visual or infrared range. In such systems, at least one lighting device, which is allocated to one of the image recording devices, is used for the irradiation of the markers. Retroreflectors as markers have the advantage of reflecting back a major part of the incident light in the direction of incidence.

In most of the applications of optical tracking systems, a large extent of the distance between image recording device (camera) and object (target) must be covered. Consequently, the system must deliver sufficiently accurate results for small distances just as for large distances between camera and target. However, the image recording devices (CCD chips) which are usual for optical tracking system have a dynamic range with upper and lower limit, i.e. a signal below a lower intensity limit of the incident signal can no longer be satisfactorily separated from the background and above an upper intensity limit saturation effects occur. Because of this, the position determination becomes less accurate. For optical tracking systems with passive (retroreflecting markers) and a non-variable luminous intensity, the extent of the distance to be covered between the camera and the target in many cases of application is so large that in the normal operation the lower limit or the upper limit of the dynamic range is fallen short of or exceeded, respectively.

Two solutions are suggested for this problem, without however solving the problem satisfactorily: Operating with an automatic diaphragm or controlling the luminous intensity similarly to a computer flash. However, both solutions are impractical. For cameras with an automatic diaphragm, the required accuracy of the image correction can no longer be guaranteed. The use of a “computer flash”, which adds up the incoming light energy and upon reaching a limit value stops the lighting, will in many cases, because of nonspecific reflexes (mirroring surfaces) or external sources of interference (e.g. spotlights), deliver unusable results. Even a situation which is typical in the practice, for example, the illumination of two targets, out of which one is located near the tracking camera (image recording device) and one far away from it, cannot be satisfactorily mastered with this type of computer flash.

It is possible to solve this problem with the data retransfer according to the invention. From a computing device (central computing device) the tracking cameras (image recording devices) receive information about the current distance of the markers to the individual image recording devices and about the type of markers. For each individual image recording device, the luminous intensity can then be set to the requirements. Thus, it is ensured that the system operates within the dynamic range of the image recording device.

The information, which luminous intensity is required for which distance and for which type of marker, can be taken from a given look-up table, which is the result of previous laboratory experiments.

Another possibility is to take the luminous intensity required not or not exclusively from a given table, but to adjust it as follows: information about the luminosity of the individual markers is already available in the tracking camera (image recording device) or in the associated computing device (2D-computing stage) connected to its output, as result of the computations regarding a recorded image. It is then possible to readjust the luminous intensity from image to image in such a way that the maximum luminosity (brightest pixel) of the relevant markers remains close to a specified value. This value is, for example, 80% of the maximum modulation. According to the invention, for this purpose, information about the current or expected locations of the relevant markers together with information about the luminosity of these markers is retransferred to the lighting control unit. For this, for example, data about the expected locations of markers is forwarded from the central computing device, whereas information about the luminosity of markers are transferred to the lighting control unit over a shorter path directly from the image recording device or the first (2D) computing stage connected to its output.

In addition to controlling the luminous intensity, the spatial light distribution in the image area of the image recording device also can be controlled. For this purpose, a lighting device with a light emitting zone having a plurality of subdivided segments is used, wherein the individual segments can be accessed separately. The individual segments illuminate different image areas of the image recording device, so that by means of the retransfer of information according to the invention about the location of the relevant markers to the control unit of the lighting device, only the relevant image areas can be illuminated by accessing the corresponding segment. Additionally, the direction of the rays can be controlled by diffractive or refractive optical elements, since tracking cameras usually operate with almost monochromatic light. Fresnel prismatic disks adapted to the geometry of the lighting device are suitable as refractive elements.

The entire information retransfer according to the invention, the computation of the respective retransferred information, the control and adjustment of individual components by the retransferred information, components such as image recording devices, computing devices and control units, can be carried out advantageously by means of a computer program, which is executed in a computing device specially provided for it or in the already mentioned central computing device for determining the location and/or position of the objects. A corresponding computer program product contains the computer program in a suitable data carrier, such as EEPROMs, flash memories, CD ROMs, floppy disks or hard disk drives.

In the following, the invention and its advantages are explained in detail with reference to the embodiments which are schematically illustrated in the accompanying Figures.

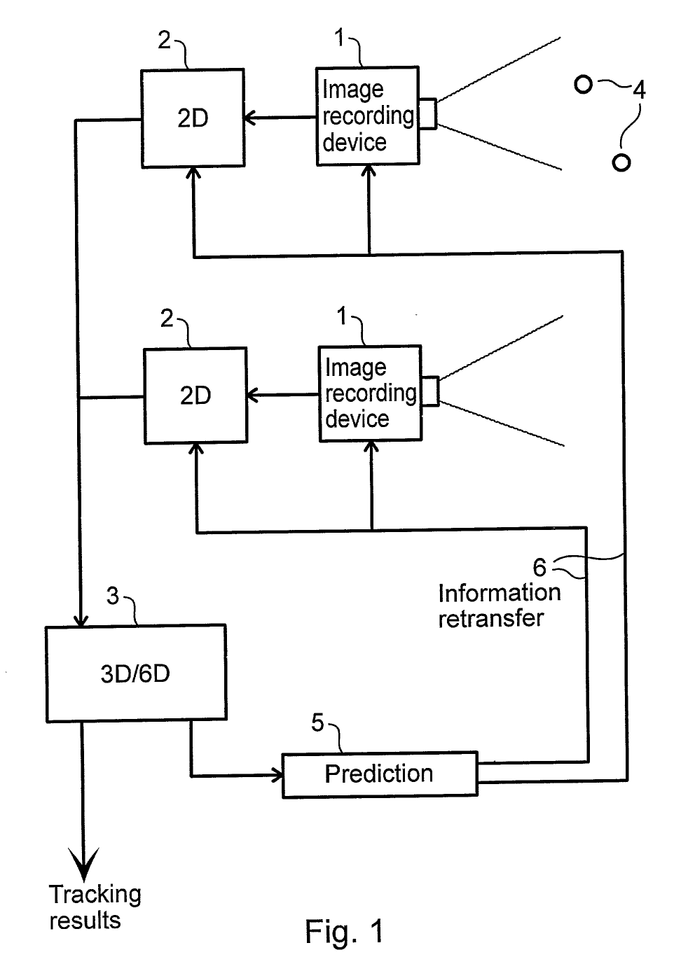

FIG. 1 shows in schematic form an embodiment of the data flow chart of an optical tracking system according to the invention.

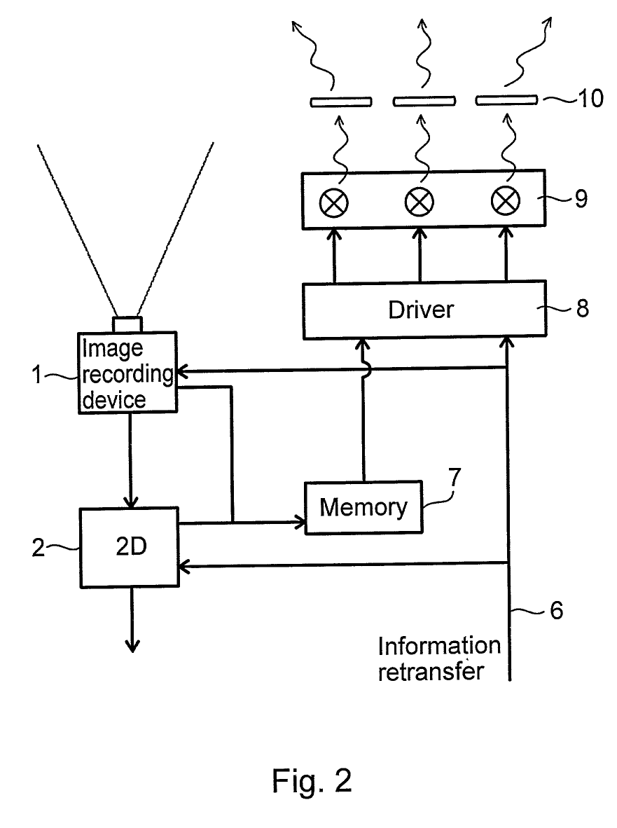

FIG. 2 shows in schematic form the data flow chart of an embodiment of a tracking system according to the invention, which operates with a lighting device for passive markers.

FIG. 1 shows a general data flow chart for the information retransfer according to the invention. The tracking system comprises a plurality of image recording devices 1, the computing devices 2 allocated to the image recording devices for determining the two-dimensional position of markers in the recorded image and a central computing device 3, in which the marker position data of the individual image recording devices 1 are collected and used for calculating the position and/or orientation data of the object. Reference should be made to the fact, that the components shown in FIG. 1 represent the data flow, which manifests itself in a logical separation of the different processing stages, and that this logical separation is not necessarily accompanied by a physical separation. Consequently, in the practice it is possible, for example, to combine the components, image recording device 1 and 2D-computing device 2 or the components, 2D-computing device 2 and 3D/6D-computing device 3 or even all three components into one apparatus, respectively. The central computing device 3 delivers the tracking results mostly to an additional, not shown computing device for further processing the results or to a not shown storage medium.

According to the invention, in this embodiment, useful data is retransferred from the central computing device 3 to the preceding processing stages, namely in this case, to the image recording device 1 and also to the computing device 2 allocated to this image recording device. The information retransfer channel is identified with 6. Physically, the information retransfer channels can use the same data transfer medium as the one for the transfer of data from image recording devices to allocated computing devices 2 and further to the central computing device 3. For better illustration, the data channels are drawn separately in the data flow chart according to FIG. 1.

In this embodiment, the means for information retransfer also include a prediction stage 5, which calculates from the result data of the direct past, expected values for the image to be captured at the moment. The data obtained is then forwarded to the image recording devices 1 and the allocated computing devices 2. Because of the prediction, the value of the retransferred data is increased further.

An object identified with markers 4 is captured during its movement in space by the image recording devices 1, which are CCD cameras. The individual images are evaluated in a succeeding computing device 2 (2D-computing stage) to the effect that the position of the markers 4 in the image is determined. Since location and orientation of the image recording device 1 are known, from the position data of the markers 4 in the images recorded, the position, i.e. the three-dimensional location, of the object can be determined in a central computing device 3 by means of appropriate trigonometric algorithms. When more than 2 markers 4 are used, additionally more information can be obtained about the orientation of the object. Depending upon the type of application, the tracking results are reused in an additional computing device, for example, for the production of virtual film sequences.

In a prediction device 5 which can be the physical part of the central computing device 3, from the tracking results taken over a specified period of time, expected results are calculated for the respective images to be captured. The expected marker locations, expected marker sizes and/or expected artifacts can be calculated as expected values. This makes it possible to read out only relevant image sections in which markers are expected, to blank out non-specific reflexes or to predict a mutual obscuring of markers. Hereby, it is possible to enhance the accuracy and speed in the image evaluation. To this end, according to the invention, the corresponding information is delivered from the prediction device 5 directly to the image recording device 1 and/or to the respective computing device 2 allocated to the image recording device 1.

A particularly appropriate use of the information retransfer according to the invention is shown in the form of a data flow chart in FIG. 2. Identical components are marked with the same reference signs. Here, a lighting device is allocated to the image recording device 1, the lighting device having a control unit 8 with a driver stage, a light emitting device 9 divided into a plurality of segments and a beam deflecting device 10. The light emitted from the segments of the light emitting device 9 is distributed by means of diffractive or refractive elements of the beam deflecting device 10 in different spatial directions. With a lighting device of this type it is possible to illuminate the markers 4 in such a way that they are imaged with optimum brightness by the image recording device 1. To this end, according to the invention, data is retransferred not only to the image recording device 1 and the computing device 2 allocated to said recording device, but also to said control unit 8 of the lighting device.

Selected data, such as luminosity information from the first processing stages, said image recording device 1 and the allocated computing device 2 is buffered for a short time in a memory 7 and then also forwarded to said control unit 8 of the lighting device. Based on the transferred data, for example, expected marker positions (refer to FIG. 1) and marker luminosity, the driver stage of said control unit 8 can access the individual segments of said light emitting device 9 with selectable luminous power. By means of the succeeding light deflecting device 10, each segment of the lighting device can then illuminate another part of the image field of the associated image recording device 1. Thereby, the spatial distribution of the illumination can be adjusted optimally from image to image.

It is also possible to forward only the information about the distances of said markers 4 to said control unit 8 of the lighting device and depending on the distance and the type of said markers 4, to control the luminous power and distribution. The access values required for this purpose can be taken from a look-up table which has been prepared by previous laboratory experiments.

In the embodiment of the lighting adjustment for passive markers according to the invention, it is advantageous to control the respective luminous intensity in such a way that the luminosity of the imaged markers lies within the dynamic range of said image recording device 1, for example, at a value of 80 percent of the upper dynamic limit.

The retransfer of relevant information according to the invention, increases in a tracking system the precision and speed of the evaluation of the resulting data.

1. An optical tracking system for determining the position and/or orientation of an object provided with at least one marker (4), using at least two image recording devices (1) for capturing the image of said at least one marker (4) and at least one succeeding computing device (2, 3) for evaluating the images captured by said image recording devices (1) for computing the position and/or the orientation of the object, characterized in that means are provided for retransferring information calculated in said computing device (2, 3) to another computing device (2) and/or to at least one of said image recording devices (1).

2. The optical tracking system of claim 1 characterized in that computing devices (2) allocated to said image recording devices (1) are provided for determining the marker positions in the captured image and that a central computing device (3) is provided for determining the position and/or the orientation of the object, said central computing device (3) is connected to said individual computing devices (2) for transferring the image data to said central computing device (3).

3. The optical tracking system of claim 2 characterized in that the means for retransferring calculated information include means for retransferring information calculated in said central computing device (3) to a computing device (2) allocated to an image recording device (1) and/or to an image recording device (1).

4. The optical tracking system of claim 1 characterized in that the means for retransferring calculated information include a prediction unit (5), which from the calculated tracking results calculates an expected position and/or orientation information for the object.

5. The optical tracking system of claim 1 characterized in that the means for retransferring calculated information include the data transfer means for the data transfer from an image recording device (1) to said at least one succeeding computing device (2, 3).

6. The optical tracking system of claim 1 characterized in that the information transfer occurs via Ethernet connections.

7. The optical tracking system of claim 1, having at least one lighting device (8, 9, 10) allocated to an image recording device (1) for lighting of reflecting markers (4) characterized in that means are provided for transferring information calculated in a computing device (2, 3) to said lighting device (8, 9, 10).

8. The optical tracking system of claim 7 characterized in that the means for transferring information to said lighting device (8, 9, 10) include a memory (7).

9. The optical tracking system of claim 7 characterized in that the means for transferring information to said lighting device (8, 9, 10) include a look-up table.

10. The optical tracking system of claim 7 characterized in that said lighting device (8, 9, 10) includes a light emitting device (9) divided into a plurality of segments which can be controlled separately by a control unit (8).

11. The optical tracking system of claim 7 characterized in that said lighting device (8, 9, 10) includes a beam deflecting device (10), in particular, consisting of diffractive or refractive elements.

12. The optical tracking system of claim 11 characterized in that Fresnel prismatic disks represent the refractive elements.

13. A method for determining the position and/or orientation of an object provided with at least one marker (4) wherein the image of said at least one marker (4) is captured by said at least two image recording devices (1) and from the obtained image data the position and/or orientation of the object is calculated by means of at least one computing device (2, 3) characterized in that for controlling the computation and/or image recording process, information calculated by a computing device (2, 3) is retransferred to another computing device (2) or to at least one of said image recording devices (1).

14. The method of claim 13 characterized in that output information is retransferred.

15. The method of claim 13 characterized in that information loaded into the system from outside, which is relevant for the position and/or orientation determination, is retransferred.

16. The method of claim 13 characterized in that currently determined position and/or orientation information is retransferred.

17. The method of claim 13 characterized in that on the basis of the current position and/or orientation information, a prediction for the calculation of expected position and/or orientation information is carried out and that the latter information is retransferred.

18. The method of claim 13 wherein reflecting markers are lighted by a lighting device (8, 9, 10) allocated to an image recording device (1) characterized in that the retransferred information is used for controlling said lighting device (8, 9, 10).

19. The method of claim 18 characterized in that the luminous power of said lighting device (8, 9, 10) is controlled.

20. The method of claim 18 characterized in that the spatial light distribution of said lighting device (8, 9, 10) is controlled.

21. The method of claim 18 characterized in that a previously prepared look-up table is used for controlling said lighting device (8, 9, 10).

22. The method of claim 18 characterized in that the luminous intensity is controlled in such a way that the maximum luminosity of said imaged markers (4) remains close to a predetermined value, particularly at approximately 80% of the maximum resolvable luminosity.

23. A computer program with program code means for executing all steps of any of claims 13 to 22, when the computer program is executed on a computer or on said at least one computing device (2, 3).

24. A computer program product with program code means, which are stored in a computer-readable data carrier, for executing a method of any of claims 13 to 22, when the computer program is executed on a computer or on said at least one computing device (2, 3).
